(19) United States
(12) Patent Application Publication
(10) Pub. No.: US 2016/0050513 A1
(43) Pub. Date: Feb. 18, 2016

(54) RF FRONT-END ARCHITECTURE FOR MACHINE-TO-MACHINE APPLICATIONS

(71) Applicant: AVIACOMM INC., Sunnyvale, CA (US)

(72) Inventors: Hans Wang, Mountain View, CA (US); Tao Li, Campbell, CA (US); Binglei Zhang, San Jose, CA (US); Shih Hsiung Mo, San Jose, CA (US)

(73) Assignee: AVIACOMM INC., Sunnyvale, CA (US)

(21) Appl. No.: 14/791,382

(22) Filed: Jul. 3, 2015

Related U.S. Application Data
(60) Provisional application No. 62/038,005, filed on Aug. 15, 2014.

(51) Int. Cl. H04W 4/00; H04Q 9/00

(52) U.S. Cl. CPC H04W 4/005; H04Q 9/00

(57) ABSTRACT

One embodiment of the present invention provides an RF front-end module for machine-to-machine applications. The RF front-end module includes an integrated circuit (IC) chip that comprises multiple functional blocks. The multiple functional blocks include at least a transmission chain, a receiving chain, a synthesizer, and one or more interfaces for interfacing with other off-chip front-end components.

### RELATED APPLICATION

This application claims the benefit of U.S. Provisional Application No. 62/038,005, Attorney Docket Number AVC14-1002PSP, entitled “RF Front End Architecture for Machine-to-Machine (M2M) Application,” by inventors Hans Wang, Tao Li, Binglei Zhang, and Shih Hsiung Mo, filed 15 Aug. 2014.

### BACKGROUND

1. Field

The present disclosure relates generally to radio frequency (RF) front-end components. More specifically, the present disclosure relates to an RF front-end architecture that is suitable to be used for machine-to-machine (M2M) communications.

2.Related Art

Machine-to-machine (M2M) communications play an important role in the emerging technology of the Internet of Things (IoT), which is the interconnection of uniquely identifiable embedded computing devices within the existing Internet infrastructure. More specifically, M2M communications refers to any technology that enables networked devices to exchange information and perform actions without the manual assistance of humans.

In its early stages, M2M communications technology, such as telemetry, was used for the purpose of remote monitoring, relying on telephone lines, and later, on radio waves, for transmission of the measured operational data. The emergence of the Internet and the prevalence of public wireless networks have expanded the role of M2M communications from pure science, engineering and manufacturing to everyday use in products like home heating units, electric meters and Internet-connected appliances. For example, utility companies have been using so-called “smart” meters to record consumption of utility usage periodically and communicate that information back to the utility companies for monitoring and billing purposes. Moreover, in a so-called “smart” home, various appliances are connected by a home network and are able to communicate with each other and to receive operation commands from the home owner via a mobile device carried by the owner.

Current development of the next generation of wireless networks, such as Long-Term Evolution (LTE) networks, means that M2M communications can now be carried on a network with higher speed.

### SUMMARY

One embodiment of the present invention provides an RF front-end module for machine-to-machine applications. The RF front-end module includes an integrated circuit (IC) chip that comprises multiple functional blocks. The multiple functional blocks include at least a transmission chain, a receiving chain, a synthesizer, and one or more interfaces for interfacing with other off-chip front-end components.

In a variation on this embodiment, the receiving chain includes a receiver, an analog-to-digital converter (ADC), and a digital interface for interfacing with a baseband processor.

In a further variation, the digital interface is a serial interface.

In a variation on this embodiment, the transmission chain includes a transmitter, a digital-to-analog converter (DAC), and a digital interface for interfacing with a baseband processor.

In a further variation, the digital interface is a serial interface.

In a variation on this embodiment, the function blocks further comprise a power detector coupled to the transmission chain.

In a variation on this embodiment, the functional blocks further comprise a temperature sensor.

In a variation on this embodiment, the one or more interfaces include one or more of: a Mobile Industry Processor Interface (MIPI) RF front-end interface, a general purpose input/output (GPIO) interface, and a Serial Peripheral Interface (SPI).

In a variation on this embodiment, the functional blocks further include a second digital-to-analog converter (DAC) configured to provide a control signal to an oscillator.

In a further variation, the oscillator is located off-chip, and the oscillator is a voltage controlled oscillator.

In a variation on this embodiment, the other off-chip front-end components include one or more of: a filter, a switch, and an amplifier.

In a variation on this embodiment, the transmission chain and the receiving chain are configured to operate in compliance with a Long-Term Evolution (LTE) Category 0 (Cat-0) Standard.

### BRIEF DESCRIPTION OF THE FIGURES

FIG. 1 presents a diagram illustrating the architecture of a wireless network that implements remote radio head.

FIG. 2 presents a diagram illustrating the architecture of a conventional single channel RRH (prior art).

FIG. 3 presents a diagram illustrating the exemplary architecture of a multi-stream RRH, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide an RF front-end architecture for machine-to-machine (M2M) communications application. More specifically, to ensure smaller size and lower power consumption, the RF front-end includes a radio frequency integrated circuit (RFIC) chip that absorbs as many as possible of the discrete RF front-end components. More specifically, the RFIC includes multi-channel transceivers, analog-to-digital converters (ADCs) and digital-to-analog converters (DACs) with digital interfaces, power detectors, standardized interfaces to other RF front-end components, phase-lock loop (PLL) synthesizers, a standardized interface to the base station, and a temperature sensor. RF Front-End for M2M Application

Machine-to-machine (M2M) communications technology has existed since the advent of computer networking automation, and has been utilized in applications such as telemetry, industrial automation, and supervisory control and data acquisition (SCADA). When used in these traditional settings, M2M communications often involves a device, such as a sensor or a meter, which is used to capture an event, such as a temperature reading or utility usage reading. The captured event is then relayed through a wired or wireless network to an application (such as a software program) that translates the captured event into meaningful information. Traditionally, the communication among the machines is often accomplished by having a dedicated remote network of machines relaying information back to a central hub for analysis. However, due to the low cost and ubiquity of cellular networks, such as Global System for Mobile Communication (GSM), many modern telemetry systems transmit and receive data over the cellular networks. For example, certain telemetry systems may use short message service (SMS) to transmit and receive data.

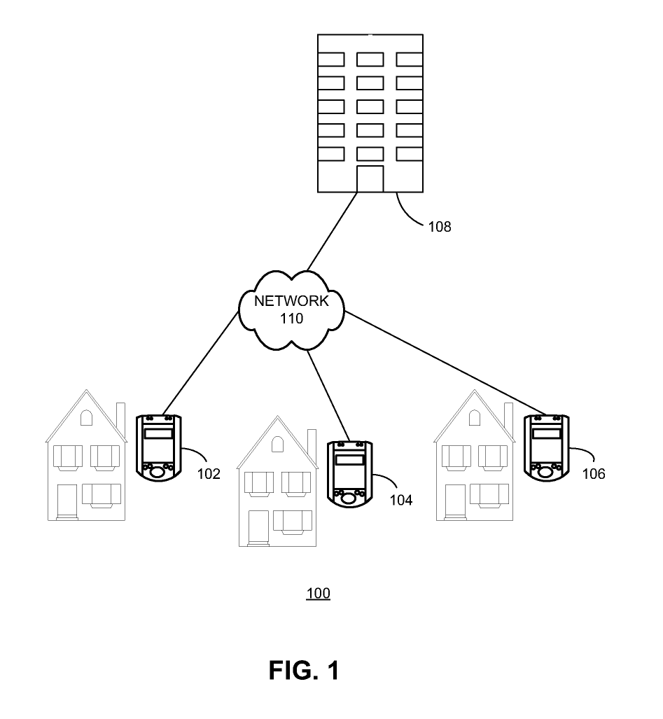

FIG. 1 presents a diagram illustrating an exemplary scenario of machine-to-machine communications. In FIG. 1, a smart grid 100 includes a number of smart meters associated with a number of individual homes, such as smart meters 102, 104, and 106. These smart meters communicate with a controller located in a central office 108 via a network 110, which can include a public wireless network. More specifically, smart meters 102-106 can transmit data, such as utility usage data or sensory data, associated with the individual homes to central office 108, and can receive commands from central office 108. To enable such two-way communication, each smart meter is equipped with a wireless communication interface.

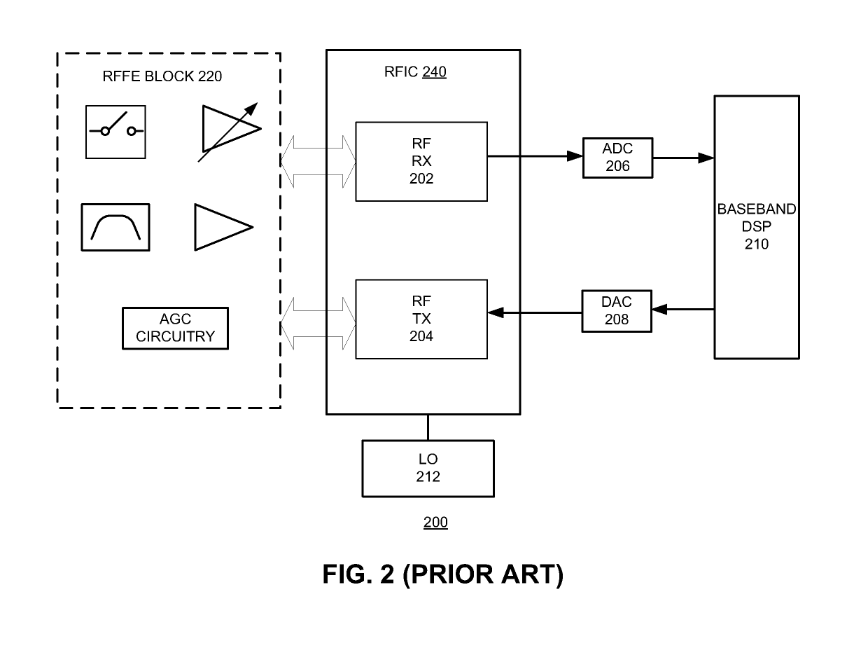

FIG. 2 presents a diagram illustrating a conventional wireless communication interface (prior art). In FIG. 2, a wireless communication interface 200 includes a number of functional blocks, some are integrated onto an integrated circuit (IC) chip and some includes discrete components. For example, wireless communication interface 200 can include an RFIC 240, which includes an RF receiving (RX) module 202 and an RF transmitting (TX) module 204. RF RX 202 sends a demodulated signal to an off-chip analog-to-digital converter (ADC) module 206 to be converted to the digital domain, and the digital signal is sent to a baseband digital signal processor (DSP) 210 for further processing. In the transmitting (TX) direction, RF TX module 204 receives analog signals in baseband from digital-to-analog converter (DAC) module 208, and modulates the baseband signal to the RF domain. Wireless communication interface 200 also includes an RF front-end (RFFE) block 220, which includes a number of discrete RFFE components, such as switches, filters, amplifiers, and automatic gain control (AGC) circuitries, etc.; and a local oscillator (LO) 212.

As one can see from FIG. 2, the wireless communication interface includes IC chips and a number of discrete components. The interfaces between the ICs and the discrete components can be complex and bulky. As a result, the size and the amount of energy consumed by the wireless communication interface can be relatively large. However, for M2M applications, such as smart meters, the remote nodes are often battery powered and are expected to last a long time without the need for battery replacement. Therefore, an ideal M2M wireless communication interface should have low power consumption. Moreover, to reduce cost, the ideal M2M wireless communication interface should have a smaller form factor.

In recent years, the rapid deployment of Long-Term Evolution (LTE) wireless networks has made M2M communications over LTE the current industrial trend. To enable such bi-directional communications, each smart meter is equipped with a communication interface, often a wireless interface, to transmit data and receive commands. In current commercially available smart meters, the wireless interface is designed for second generation (2G) and third generation (3G) wireless networks. As wireless networks migrate toward LTE (also referred to as 4G), it is desirable to develop smart meters or home appliances that can communicate over the LTE network.

Compared with other applications over LTE, such as voice calls and web browsing, M2M communications requires a relatively lower bandwidth, which can be around 1 Mbps. In addition to low bandwidth, low cost and low power consumption are key design requirements for the M2M communications interface. The newly developed LTE Category 0 (Cat-0) Standard reduces the complexity of an LTE modem, and is suitable for M2M application. More specifically, LTE Cat-0 operates with only one transmit/receive antenna (instead of multi-input multi-output (MIMO) used in other LTE standards), has a single RF chain, and offers half duplex capability. In some embodiments, a compact, low power-consumption RF front-end architecture that meets the LTE Cat-0 Standard is provided to be used for the M2M application.

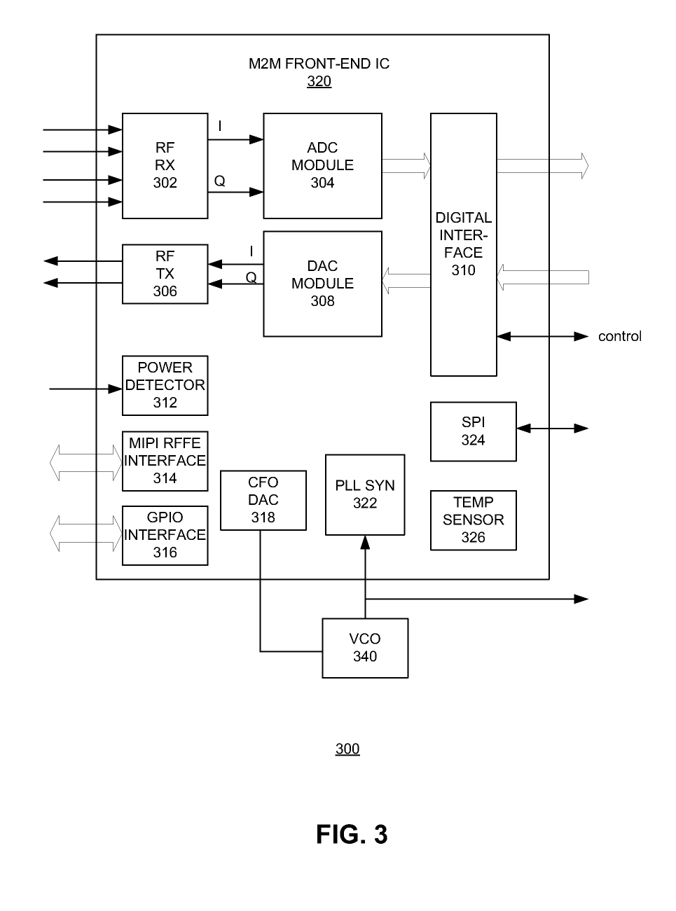

FIG. 3 presents a diagram illustrating the exemplary architecture of an RF front-end for use in a machine-to-machine application, in accordance with an embodiment of the present invention. Note that, in this disclosure, the term “RF front-end” is loosely used to include any circuitries between the antenna and the baseband processor. In FIG. 3, an M2M RF front-end module 300 includes an IC chip 320 and a voltage-controlled oscillator (VCO) 340.

M2M front-end IC 320 includes a number of functional blocks, such as an RF receiving (RX) module 302, a analog-to-digital converter (ADC) module 304, an RF transmitting (TX) module 306, a digital-to-analog converter (DAC) module 308, a digital interface 310, a power detector 312, a Mobile Industry Processor Interface (MIPI) RF front-end interface 314, a general purpose input/output (GPIO) interface 316, a CFO (carrier frequency oscillator) DAC 318, a phase lock loop (PLL) synthesizer (SYN) module 322, an SPI (Serial Peripheral Interface) 324, and a temperature sensor 326.

RF RX module 302 and ADC module 304 form a single RX chain. More specifically, RX module 302 can include multiple inputs. In some embodiments, RX module 302 can include up to four inputs, capable of receiving RF signals in up to four channels. Depending on the modulation scheme, RX module 302 may include different types of demodulators. For example, RX module 302 may include a quadrature demodulator if the received RF signals are quadrature modulated. In some embodiments, RX module 302 includes quadrature demodulators, and the demodulated in-phase (I) and quadrature (Q) signals are separately fed to ADC module 304, which can include up to eight ADCs (two for each RX channel).

Similarly, RF TX module 306 and DAC module 308 form a single TX chain. TX module 306 can include multiple outputs. In some embodiments, TX module 306 includes two outputs for outputting RF signals in two different channels. In some embodiments, TX module 306 includes quadrature modulators that receive I and Q signals from DAC module 308, and modulate the I and Q signals to the RF domain. Note that DAC module 308 can include up to four DACs, with two DACs serving each TX channel. In the example shown in FIG. 3, M2M front-end module 300 provides more receiving channels than transmitting channels, because it is more likely to receive complicated control signals from the central controller than to send data to the central controller. Power detector 312 is responsible for detecting the transmitted power in order to provide TX output power control. In some embodiments, power detector 312 includes two inputs that are coupled to the two outputs of RF TX module 306.

In some embodiments, the bandwidth of the RX and TX modules can range from a few Kbps to a few Mbps. In further embodiments, the bandwidth of the RX and TX modules can be around 1 Mbps. In some embodiments, the RX and TX modules work in a half-duplex mode, i.e., the RX and TX modules operate at different time slots. In further embodiments, the RX and TX chains are in compliance with the LTE Cat-0 Standard.

In FIG. 3, ADC module 304 and DAC module 308 couple to the baseband processor (not shown in FIG. 3) via a digital interface 310. In some embodiments, digital interface 310 is a serial interface, such as a JESD20x serial interface, with the 8n-bit output of ADC module 304 sent to the baseband processor in series. Similarly, the 4 m-bit input to DAC module 308 is also received in series. In addition to the serial input/output, digital interface 310 also receives/sends control signals from/to the baseband processor.

In addition to the RX and TX paths, M2M front-end module 300 also includes a number of interfaces for interfacing with other front-end components, which can include discrete components, such as filters or switches. In some embodiments, M2M front-end module 300 can include one or more MIPI RF front-end (RFFE) interfaces, such as MIPI RFFE interface 314, which enables M2M front-end module 300 to interact with MIPI-ready front-end components. However, not all RFFE devices are MIPI-ready. In order to interact with other, non MIPI-ready RFFE devices, M2M front-end module 300 includes one or more GPIO interfaces, such as a GPIO interface 316. Additionally, M2M front-end module 300 can also include an SPI 324 for interfacing with other off-chip components, such as a programmable logic device (CPLD).

CFO DAC 318 is responsible for outputting a voltage signal that can control VCO 340, which provides sinusoidal waves to PLL synthesizer 322. In some embodiments, PLL synthesizer module 322 includes two synthesizers that provide local oscillator (LO) signals to modulators/demodulators that are included in the RX module 302/TX module 306. In addition, PLL synthesizer module 322 may also provide clock signals to ADC module 304 and DAC module 308.

Temperature sensor 326 is responsible for measuring temperature.

One can see from FIG. 3 that most of the standard RF front-end components are integrated onto a single IC, with the exception of VCO 340 and other discrete components, such as filters and switches. Such a high level of integration not only ensures a compact device size, but also lowers the fabrication cost. Moreover, the on-chip integrated ADCs/DACs with serial digital interface also reduce required board area and pin-count.

Compared with the conventional wireless interface, the M2M front-end module shown in FIG. 3 integrates as many as possible of the discrete components onto the RFIC, such as the power detector, the CFO DAC, the synthesizer, the temperature sensor, etc., thus minimizing the number of external components. Such an approach can reduce the fabrication cost and the total power consumption of the wireless interface to a minimum.

In addition to the high level of integration, the IC included in the M2M RFFE module also includes a number of standard interfaces, such as MIPI, GPIO, SPI, etc., for interfacing with other external, off-chip components. This simplified external interface can also lead to reduced device size and power consumption.

Note that the architecture shown in FIG. 3 is merely an example. In practice, the compact, low-cost, low power-consumption M2M RFFE module can have different configurations. For example, the number of components that are integrated onto the IC can be more or fewer than what's shown in FIG. 3, the number of inputs and outputs of RX and TX modules can be more of fewer than what's shown in FIG. 3, and the number and type of external interfaces can also be different than what's shown in FIG. 3. Depending on the types of external RFFE components, the IC may include other types of interfaces, such as an inter-integrated circuit (I2C) interface, a one-wire bus, or a three-wire bus.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. An RF front-end module for machine-to-machine applications, comprising:
an integrated circuit (IC) chip that comprises multiple functional blocks, wherein the multiple functional blocks include at least:
a transmission chain,
a receiving chain,
a synthesizer, and
one or more interfaces for interfacing with other off-chip front-end components.

2. The RF front-end module of claim 1, wherein the receiving chain includes a receiver, an analog-to-digital converter (ADC), and a digital interface for interfacing with a baseband processor.

3. The RF front-end module of claim 2, wherein the digital interface is a serial interface.

4. The RF front-end module of claim 1, wherein the transmission chain includes a transmitter, a digital-to-analog converter (DAC), and a digital interface for interfacing with a baseband processor.

5. The RF front-end module of claim 4, wherein the digital interface is a serial interface.

6. The RF front-end module of claim 1, wherein the functional blocks further comprise a power detector coupled to the transmission chain.

7. The RF front-end module of claim 1, wherein the functional blocks further comprise a temperature sensor.

8. The RF front-end module of claim 1, wherein the one or more interfaces include one or more of:
a Mobile Industry Processor Interface (MIPI) RF front-end interface;
a general purpose input/output (GPIO) interface; and
a Serial Peripheral Interface (SPI).

9. The RF front-end module of claim 1, wherein the functional blocks further include a second digital-to-analog converter (DAC) configured to provide a control signal to an oscillator.

10. The RF front-end module of claim 8, wherein the oscillator is located off-chip, and wherein the oscillator is a voltage-controlled oscillator.

11. The RF front-end module of claim 1, wherein the other off-chip front-end components include one or more of:
a filter;
a switch; and
an amplifier.

12. The RF front-end module of claim 1, wherein the transmission chain and the receiving chain are configured to operate in compliance with a Long-Term Evolution (LTE) Category 0 (Cat-0) Standard.
